(19) United States
(12) Patent Application Publication
(10) Pub. No.: US 2025/0066158 A1
(43) Pub. Date: Feb. 27, 2025

(54) FLOOR POSITION DETECTION DEVICE OF AN ELEVATOR SYSTEM

(71) Applicant: Inventio AG, Hergiswil (CH)

(72) Inventor: Eric Birrer, Buchrain (CH)

(21) Appl. No.: 18/720,689

(22) PCT Filed: Dec. 19, 2022
(86) PCT No.: PCT/EP2022/086641

§ 371 Date: Jun. 17, 2024

(30) Foreign Application Priority Data
Dec. 23, 2021 (EP) 21217251.4

(51) Int. Cl. B66B 1/40

(52) U.S. Cl. CPC B66B 1/40

(57) ABSTRACT

A floor position detection device for an elevator system that determines a position of a car relative to a floor has a sensor unit and an evaluation device producing a floor signal having at least two states being an “outside the range of the floor” state when outside a range of the floor and a “within the range of the floor” state when within the overall range of the floor. The sensor unit has at least two sensors that each produce a floor position characteristic value and the evaluation device produces the floor signal based on a comparison between at least two of the characteristic values. The floor signal can adopt at least two mutually distinguishable states within the range of a floor, wherein each of these states corresponds to a partial range of the range of the floor, the partial ranges fully covering the range of the floor.

### FIELD

The present invention relates to a floor position detection device of an elevator system, to an elevator control system of an elevator system, and to an elevator system.

### BACKGROUND

A generic floor position detection device is known from WO 2018/219504 A1. This known floor position detection device can be used to determine whether an elevator car of the elevator system is within a range of a floor or outside a range of a floor.

### SUMMARY

It is an object of the present invention to further develop this known floor position detection device in such a way that it is as backwards compatible as possible with the known floor position detection device and nevertheless can indicate whether the elevator car is located within the range of a floor above the door sill or below the door sill.

According to the invention, this object is achieved by the floor position detection device, by the elevator control system, and by the elevator system according to the advantageous embodiments defined and/or described in the description.

In the approach presented here, the floor signal within the range of a floor can adopt at least two, mutually distinguishable states, wherein each of these mutually distinguishable states corresponds to a partial range of the range of a floor. The partial ranges fully cover the range of a floor.

A floor position detection device can thereby be realized in a simple manner which can detect a plurality of positions relative to a door sill in the range of a floor of the elevator car. Furthermore, the floor position detection device according to the invention can also be used with elevator control systems which are designed for the use of the floor position detection device according to WO 2018/219504 A1.

According to one aspect of the invention, the floor position detection device has a sensor unit and an evaluation device for producing a floor signal having at least two states. The floor position detection device is used in an elevator system to determine a position of a car of the elevator system relative to a floor. The floor signal can adopt at least one “outside the range of the floor” state outside a range of a floor and a “within the range of the floor” state within the overall range of the floor. The sensor unit has at least two sensors which each produce a floor position characteristic value. Furthermore, the evaluation device is configured to produce the floor signal on the basis of a comparison between at least two of the floor position characteristic variables, wherein the floor signal can adopt at least two, mutually distinguishable states within the range of a floor, and wherein each of these mutually distinguishable states corresponds to a partial range of the range of a floor, wherein the partial ranges fully cover the range of a floor.

The floor position detection device or the evaluation device transmits the floor signal via a communications connection to an elevator control of the elevator system. The elevator control uses the floor signal particularly for the accurate positioning of an elevator car that can be moved in an elevator shaft on a floor or a shaft door associated with a floor. To indicate the position of a floor in a travel direction of the elevator car, at least one magnetic means is placed in the elevator shaft at a position designating the location of the floor. For example, the magnetic means can be arranged on the shaft door associated with the floor and the floor position detection device on the elevator car-particularly on a car door of the elevator car. This allows the elevator control to use the floor signal to position the car door and therefore the car accurately opposite the shaft door of the floor. The mentioned magnetic means may also be considered part of the floor position detection device.

When the magnetic means is at the correct position in the elevator shaft, and the floor position detection device is at the correct position on the elevator car, the “in the range of the floor” state of the floor signal shows that the elevator car is correctly positioned opposite the floor. The car door, in particular, can then be opened, which, in the usual manner, also opens the shaft door associated with the floor. In this case, the “outside the range of the floor” state of the floor range shows that the elevator is not positioned in the immediate vicinity of a floor or at least not yet completely correctly opposite the floor, and that in particular the car door cannot be opened. Furthermore, by subdividing the range of a floor into partial ranges, information can be transmitted to the elevator controller about which position the elevator car is located in relative to the floor, so that the position can be corrected. This can be necessary, for example, when an elevator car is being loaded or unloaded, or when people are entering or exiting the elevator car. In both cases, the total weight of the elevator car, including an additional load, changes. Weight changes can lead to a change in position of the car within the shaft, which is corrected by the elevator controller.

The designations “within the range of the floor” and “outside the range of the floor” are only exemplary designations for two different states of the floor signal.

The floor position detection device can be designed such that the at least two sensors of the sensor unit are formed by sensors for measuring a field. This allows a measurement of the field surrounding the element generating the field. For example, the field can be generated by a magnet, wherein the field is a magnetic field in this case. For example, Hall effect sensors can be used to measure the magnetic field.

The floor position detection device can be designed such that a unique floor signal can be derived from the floor position characteristic values at each position of the elevator car. This makes it possible, for example, to immediately determine the position of the elevator car relative to a floor after a power failure, without the elevator car having to move to determine the position.

The floor position detection device can be designed to detect one of the states in each position of the elevator car, wherein the states are the “outside the range of the floor” state and one of the mutually distinguishable states within the range of a floor.

The floor position detection device can be designed to detect the entry direction into the range of a floor by means of the sensor unit.

The floor position detection device can be designed to subdivide the range of a floor at least into an upper partial range and a lower partial range, wherein the floor signal adopts the “within the upper partial range of the range of the floor” state in the upper partial range and adopts the “within the lower partial range of the range of the floor” state in the lower partial range.

The floor position detection device can be designed such that the floor signal is mapped by a voltage at an output of the evaluation device or at an output of an output module connected to the evaluation device, wherein each state is characterized by one or more voltages and/or voltage ranges. It is particularly advantageous to assign corresponding, different voltages to the range of a floor, wherein these voltages are in a voltage range in which in particular the voltage associated with the “outside the range of the floor” state is not located. For example, the voltage 0 volts can be associated with the “outside the range of the floor” state, the voltage 10 volts can be associated with the “within the upper partial range of the range of the floor” state, and the voltage 24 volts can be associated with the “within the lower partial range of the range of the floor” state. Furthermore, the voltage range for the “within the range of the floor” state can be defined by a voltage greater than 8 volts, wherein no upper voltage is absolutely necessary for the range. Alternatively, the “within the upper partial range of the range of the floor” state could also be characterized by the voltage 24 volts, and the “within the lower partial range of the range of the floor” state could also be characterized by the voltage 10 volts. Other voltages are also possible. The aforementioned voltages are only examples.

As described in WO 2018/219504 A1, the floor position detection device known from WO 2018/219504 A1 outputs either 0 volts or 24 volts. However, the elevator control system in which the known floor position detection device is used detects any voltage above 8 volts as “within the range of the floor.” Consequently, the floor position detection device according to the present invention—in particular, according to this preferred embodiment—is compatible with the floor position detection device known from WO 2018/219504 A1.

Furthermore, the “within the range of the floor” state can be characterized by a plurality of voltages different from one another, wherein each of these voltages is associated with one of the partial ranges of the range of a floor.

A further aspect of the invention relates to an elevator control system of an elevator system having the floor position detection device as described above and below.

A further aspect of the invention relates to an elevator system having the elevator control system as described above and below.

Further advantages, features, and details of the invention can be found in the following description of embodiments and with reference to the drawings, in which like or functionally like elements are provided with identical reference signs.

### DESCRIPTION OF THE DRAWINGS

In the figures, in a purely schematic manner:

FIG. 1 shows a part of an elevator system having an elevator car, on which a floor position detection device is arranged, in an elevator shaft,

FIG. 2 is a schematic representation of a floor position detection device,

FIG. 3 shows the progression of floor position characteristic values and a floor signal when an elevator car passes magnetic means designating a floor,

FIG. 4 shows, according to a further exemplary embodiment, the progression of floor position characteristic values and a floor signal when an elevator car passes magnetic means designating a floor,

FIG. 5 shows, according to a further exemplary embodiment, the progression of floor position characteristic values and a floor signal when an elevator car passes magnetic means designating a floor, and

FIG. 6 shows, according to a further exemplary embodiment, the progression of floor position characteristic values and a floor signal when an elevator car passes magnetic means designating a floor.

### DETAILED DESCRIPTION

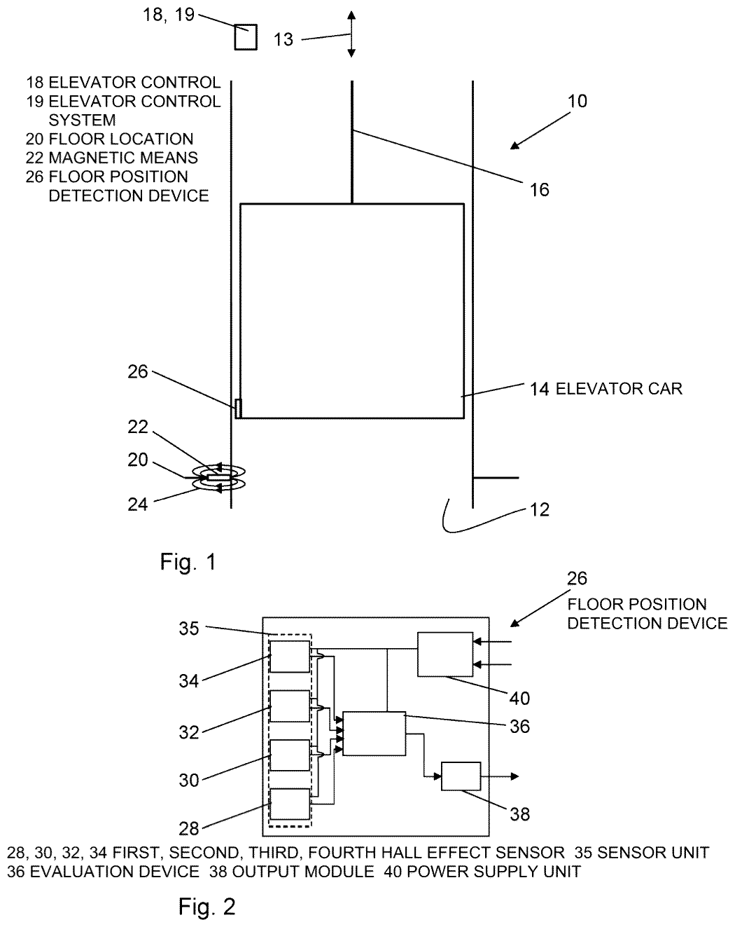

According to FIG. 1, an elevator system 10 has an elevator car 14 movable in an elevator shaft 12. The elevator car 14 is suspended by carrying means 16 in the shape of a rope or a belt and can be driven up and down in the elevator shaft 12, i.e., in a travel direction 13, by means of a drive machine (not shown). The elevator system 10 is controlled by an elevator control 18, which control, among other things, has a signal connection with the drive machine via communications connections (not shown).

In the elevator shaft 12, a magnetic means 22 in the shape of a permanent magnet is arranged at a location 20 that designates a floor. The magnetic means 22 is surrounded by a magnetic field 24 generated by it, which field is symbolically represented by some magnetic field lines. The magnetic means 22 designates the floor in the vertical direction, i.e., in the travel direction 13 of the elevator car 14. For example, it can be arranged on a shaft door that is not shown.

A floor position detection device 26 is arranged on the elevator car 14, which device is in communications connection with the elevator control 18 and whose structure is represented in more detail in FIG. 2. The floor position detection device 26 is arranged on the elevator car 14 in such a manner that it preferably is at a horizontal distance of between 5 and 25 mm to the magnetic means 22 when passing the magnetic means 22. The floor position detection device 26 can be arranged, for example, on a car door that is not shown.

The floor position detection device 26 and the elevator control 18 are components of an elevator control system 19 of the elevator system 10. The elevator control system 19 comprises in particular other sensors and actuators that are not shown.

According to FIG. 2, the floor position detection device 26 has a first Hall effect sensor 28, a second Hall effect sensor 30, a third Hall effect sensor 32, and a fourth Hall effect sensor 34 arranged one above the other in the travel direction 13. The four Hall effect sensors 28, 30, 32, and 34 form a sensor unit 35. When the floor position detection device 26 is arranged on the elevator car 14, the four Hall effect sensors 28, 30, 32, 34 are arranged in such a way that they are all at essentially the same minimum distance from the magnetic means 22 when the elevator car 14 passes the magnetic means 22.

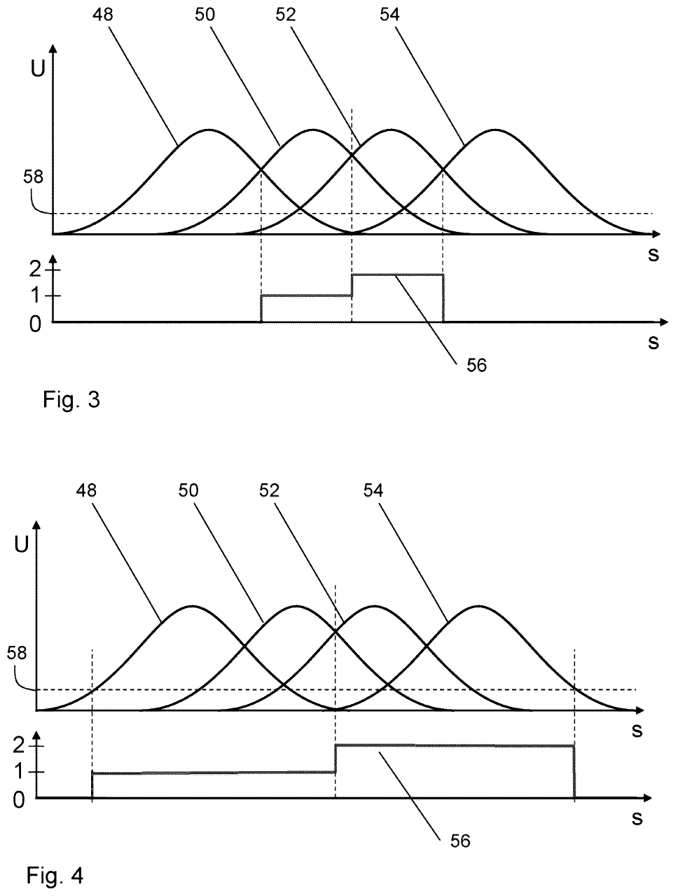

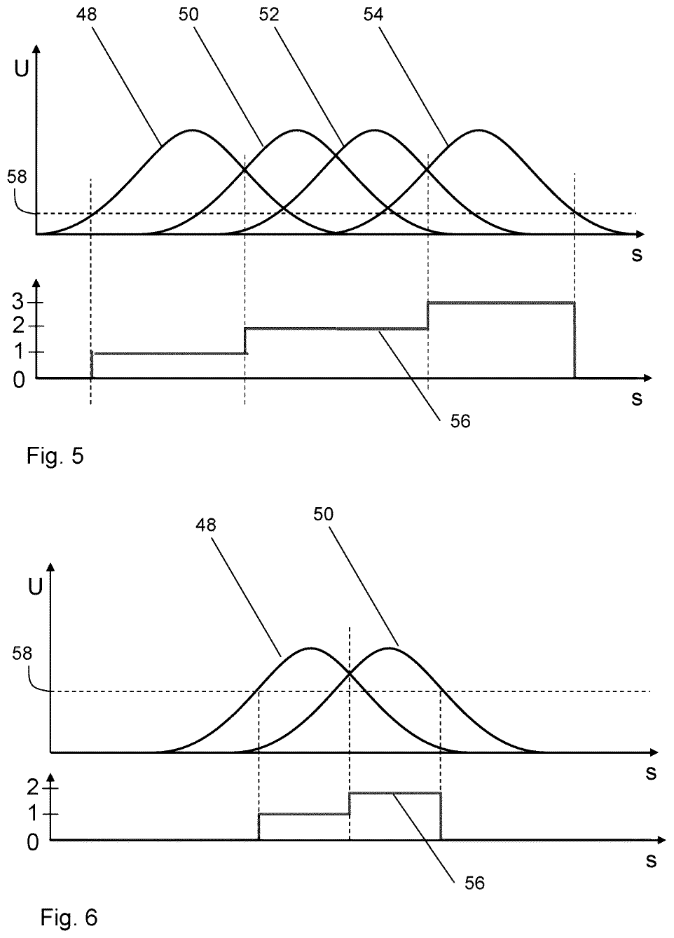

Sensor signals of the four Hall effect sensors 28, 30, 32, 34 are forwarded to an evaluation device 36, which device is implemented as a programmable microprocessor. The evaluation device 36 first calculates four floor position characteristic values from the sensor signals mentioned and links them to a floor signal, which passes them to an output module 38. The output module 38 amplifies the floor signal and forwards it to the elevator control 18. The progression of the floor position characteristic values and the floor signal at the output of the evaluation device 36 is shown in FIG. 3, FIG. 4, FIG. 5, and FIG. 6. In these figures, the sensor position “s” is the abscissa (x coordinate) and the signal value “U, 0-3” is the ordinate (y coordinate). The output module 38 could also be dispensed with. Instead of the analog output signal described below at the output of the output module 38, the output module could also supply a purely digital output signal.

In order to calculate the floor position characteristic values, the evaluation device 36 calibrates the sensor signals of the four Hall effect sensors 28, 30, 32, 34 to compensate for possible measurement differences of the individual Hall effect sensors 28, 30, 32, 34. For this purpose, the evaluation device 36 multiplies each sensor signal by a corresponding calibration factor. The calibration factors are determined during a calibration of the floor position detection device 26 to complete production of the floor position detection device 26. For this purpose, one each of four, identical magnetic means is arranged at a fixed distance in front of the four Hall effect sensors 28, 30, 32, 34. The mentioned distance is selected so that each of the four sensor signals of the four Hall effect sensors 28, 30, 32, 34 safely exceeds a threshold value. As soon as the evaluation device 36 detects that all four sensor signals are greater than the threshold value, it automatically starts a calibration. The calibration factors are determined in such a manner that, during calibration, each floor position characteristic value resulting from the multiplication of the sensor signal with the corresponding calibration factor has the same value of, for example, 300 mV. Alternatively, the calibration can also take place during a learning run of the elevator car 14.

The floor position detection device 26 also has a power supply unit 40, which supplies the four Hall effect sensors 28, 30, 32, 34, the evaluation device 36, and the output module 38 with a supply voltage. The power supply unit 40 supplies the four Hall effect sensors 28, 30, 32, 34 and the evaluation device 36 with the same 2 V supply voltage and the output module 38 with a different 24 V supply voltage. The power supply unit 40 and therefore the floor position detection device 26 are supplied with an input voltage of 24 V for this purpose. Of course, other voltages could also be used.

In FIG. 3, the progressions of floor position characteristic values, as well as of a corresponding floor signal when passing the magnetic means 22 of the elevator car 14 and therefore of the floor position detection device 26 are shown from top to bottom. Or, in other words, FIG. 3 specifies the floor signal as a function of the position of the elevator car relative to the floor, wherein the relative position is measured from above.

Curve 48 shows the first floor position characteristic value of the first Hall effect sensor 28, curve 50 shows the second floor position characteristic value of the second Hall effect sensor 30, curve 52 shows the third floor position characteristic value of the third Hall effect sensor 32, and curve 54 shows the fourth floor position characteristic value of the fourth Hall effect sensor 34. Curve 56 shows the progression of the floor signal. The floor signal 56 can adopt the “outside the range of the floor” state and “within the range of the floor” state, wherein the “within the range of the floor” state in this exemplary embodiment is subdivided into the two, mutually distinguishable states, “within the upper partial range of the range of the floor” and “within the lower partial range of the range of the floor.”

Furthermore, in FIG. 3, the “outside the range of the floor” state is marked “0,” the “within the upper partial range of the range of the floor” state is marked “1,” and the “within the lower partial range of the range of the floor” state is marked “2.” The “within the range of the floor” state is characterized by a value greater than or equal to “1.”

The floor signal 56 is amplified by the output module 38 as follows:

The logic signal “0,” which corresponds to the “outside the range of the floor” state, is mapped to a voltage of 0 volts at the output of the output module 38. The logic signal “1,” which corresponds to the “within the upper partial range of the range of the floor” state, is mapped to a voltage of 10 volts at the output of the output module 38. The logic signal “2,” which corresponds to the “within the lower partial range of the range of the floor” state, is mapped to a voltage of 24 volts at the output of the output module 38. Furthermore, a voltage of, for example, more than 8 V corresponds to the “within the range of the floor” state. Of course, the specified voltages are only exemplary and not limiting to the invention.

The floor position characteristic values 48, 50, 52, and 54 rise from a quiescent level when the Hall effect sensor in question 28, 30, 32, and 34 enters the range of the magnetic means 22, i.e., is immersed in the magnetic field 24. They reach their maximum when the Hall effect sensor 28, 30, 32, and 34 in question is precisely at the level of the magnetic means 22, in order to sink back to the quiescent level when moving away from the magnetic means 22. From the size of the associated floor position characteristic values 48, 50, 52, and 54, therefore, the distance of the corresponding Hall effect sensor 28, 30, 32, 34 from the magnetic means 22 in travel direction 13 can be inferred.

The first Hall effect sensor 28 and the second Hall effect sensor 30 are arranged in such a manner that, when the floor position detection device 26 approaches the magnetic means 22 and therefore one floor, the approach can be derived from the first floor position characteristic value 48 and the second floor position characteristic value 50. This can be seen from the fact that the first floor position characteristic value 48 rises before the second floor position characteristic value 50. The evaluation device 36 assigns the floor signal 56 the “within the upper partial range of the range of the floor” state starting from the “outside the range of the floor” state if the second floor position characteristic value 50 becomes larger than or equal to the first floor position characteristic value 48, and, at the same time, the second floor position characteristic value 50 is larger than the third floor position characteristic value 52.

When the elevator car 14 further passes the magnetic means 22, the evaluation device 36 then assigns the “within the lower partial range of the range of the floor” state to the floor signal 56 if the third floor position characteristic value 52 becomes greater than or equal to the second floor position characteristic value 50, and, at the same time, the third floor position characteristic value 52 is greater than the fourth floor position characteristic value 54.

When the elevator car 14 further passes the magnetic means 22, the evaluation device 36 then assigns the “outside the range of the floor” state to the floor signal 56 if the fourth floor position characteristic value 54 becomes greater than or equal to the third floor position characteristic value 52.

When the car continues, the strengths of the floor position characteristic values 48, 50, 52, 54—in particular, also the floor position characteristic value 54—continue to decrease, so that they are all below a threshold value 58.

In addition, the relative position of the elevator car to a floor can also be determined at any point in time from the floor position characteristic values 48, 50, 52, 54 of the Hall effect sensors 28, 30, 32, 34.

The “outside the range of the floor” position is characterized by the following conditions, applicable alternatively to one another:
all floor position characteristic values 48, 50, 52, 54 are less than or equal to the threshold value 58, or
the first floor position characteristic value 48 is greater than the threshold value 58 and, at the same time, greater than the second position characteristic value 50, or
the fourth floor position characteristic value 54 is greater than the threshold value 58 and, at the same time, greater than the third position characteristic value 52.

The “within the upper partial range of the range of the floor” state is characterized in that the second position characteristic value 50 is greater than or equal to the first position characteristic value 48 and greater than or equal to the third position characteristic value 52. In addition, the second position characteristic value 50 is greater than the threshold value 58.

The “within the lower partial range of the range of the floor” state is characterized in that the third position characteristic value 52 is greater than the second position characteristic value 50 and greater than or equal to the fourth position characteristic value 54. In addition, the third position characteristic value 52 is greater than the threshold value 58.

The magnetic means 22 and the floor position detection device 26 are arranged in such a manner that the floor signal 56 has the “within the range of the floor” state when the elevator car 14 is positioned opposite a floor in such a manner that the car door and therefore also the shaft door can be opened at the same time. Furthermore, the magnetic means 22 and the floor position detection device 26 are aligned with one another in such a way that the change of the floor signal 56 between “within the upper partial range of the range of the floor” and “within the lower partial range of the range of the floor” takes place when the door sill of the elevator car door is aligned flush with the door sill of the corresponding shaft door.

The “outside the range of the floor,” “within the floor region,” “within the upper partial range of the floor,” and “within the lower partial range of the floor” states can also be defined by other conditions for the floor position characteristic values. An example is shown in FIG. 4. Of course, the vertical distances between the sensors must optionally be adapted to the conditions for the floor position characteristic values.

In the exemplary embodiment according to FIG. 4, the “outside the range of the floor” state is characterized in that all floor position characteristic values 48, 50, 52, 54 are less than the threshold value 58.

The “within the upper partial range of the range of the floor” state is characterized in that the first position characteristic variable 48 is greater than or equal to the threshold value 58, or the second position characteristic value 50 is greater than or equal to the threshold value 58 and is, at the same time, greater than or equal to the third position characteristic value 52.

The “within the lower partial range of the range of the floor” state is characterized in that the fourth position characteristic value 54 is greater than or equal to the threshold value 58, or the third position characteristic value 52 is greater than or equal to the threshold value 58 and is, at the same time, greater than or equal to the second position characteristic value 50.

Furthermore, the “within the range of the floor” state can be divided not only into two states, but also into more than two different states. For example, the “within the range of the floor” state, as shown in the exemplary embodiment according to FIG. 5, can be divided into the “within the upper partial range of the range of the floor,” “within the central partial range of the range of the floor,” and “within the lower partial range of the range of the floor” states.

In the exemplary embodiment according to FIG. 5, the “outside the range of the floor” state is characterized in that all floor position characteristic values 48, 50, 52, 54 are less than the threshold value 58.

The “within the upper partial range of the range of the floor” state is characterized in that the first position characteristic variable 48 is greater than or equal to the threshold value 58 and is, at the same time, greater than the second position characteristic value 50.

The “within the central partial range of the range of the floor” state is characterized in that the second position characteristic value 50 is greater than or equal to the first position characteristic value 48, and that the third position characteristic value 52 is greater than or equal to the fourth position characteristic value 54. In addition, it is also required that the second position characteristic value 50 or the third position characteristic value 52 be greater than the threshold value 58.

The “within the lower partial range of the range of the floor” state is characterized in that the fourth position characteristic value 54 is greater than or equal to the threshold value 58, and the fourth position characteristic value 54 is greater than or equal to the third position characteristic value 52.

Furthermore, the number of Hall effect sensors of the sensor unit can also be changed—for example, only two sensors can be used. A corresponding exemplary embodiment will be described with reference to FIG. 6.

The first Hall effect sensor provides the first floor position characteristic value 48 shown in FIG. 6, and a second Hall effect sensor provides the second floor position characteristic value 50 also shown in FIG. 6. From these two floor position characteristic values, the floor signal 56 also shown in FIG. 6 can be derived as follows:

The “outside the range of the floor” state is characterized in that the first floor position characteristic value 48 and the second floor position characteristic value 50 are less than a threshold value 58.

The “within the range of the floor” state is characterized in that the first floor position characteristic value 48 or the second floor position characteristic value 50 is greater than the threshold value 58. As in the preceding exemplary embodiments, the “within the range of the floor” state is characterized by a value of the floor signal 56 greater than or equal to 1.

The “within the upper partial range of the range of the floor” state is characterized in that the first floor position characteristic value 48 is greater than or equal to the second floor position characteristic value 50, and, at the same time, the first floor position characteristic value 48 is greater than the threshold value 58. This state is mapped by a value 1 of the floor signal 56.

The “within the lower partial range of the range of the floor” state is characterized in that the second floor position characteristic value 50 is greater than the first floor position characteristic value 48, and, at the same time, the second floor position characteristic value 50 is greater than the threshold value 58. This state is mapped by a value 2 of the floor signal 56.

It is also possible that the floor position detection device has three or more than four Hall effect sensors.

Finally, it should be noted that terms such as “having,” “comprising,” etc., do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. A floor position detection device of an elevator system for determining a position of an elevator car relative to a floor, the floor position detection device comprising:
a sensor unit having at least two sensors each producing a sensor signal representing a floor position characteristic value associated with a position of the sensor relative to the floor;
an evaluation device receiving the sensor signals from the at least two sensors and producing a floor signal having at least two states;
wherein when the floor position detection device is arranged on the elevator car, one of the states of the floor signal is an “outside the range of the floor” state when the elevator car is outside a range of the floor and another of the states of the floor signal is a “within the range of the floor” state when the elevator car is within an overall range of the floor;
wherein the evaluation device produces the floor signal based on a comparison between at least two of the floor position characteristic values of the received sensor signals; and
wherein the evaluation device produces the floor signal with at least two, mutually distinguishable states when the elevator car is within the overall range of the floor, each of the mutually distinguishable states corresponding to a partial range of the range of the floor, wherein the partial ranges fully cover the range of the floor.

12. The floor position detection device according to claim 11 wherein the at least two sensors of the sensor unit measure a field.

13. The floor position detection device according to claim 12 wherein the at least two sensors are Hall effect sensors.

14. The floor position detection device according to claim 11 wherein the floor signal is unique for each of the states based upon the floor position characteristic values at each position of the elevator car.

15. The floor position detection device according to claim 11 wherein sensor unit detects an entry direction of the elevator car into the range of the floor.

16. The floor position detection device according to claim 15 wherein the detection of the entry direction is based upon a progression of the floor position characteristic values of the sensor signals.

17. The floor position detection device according to claim 11 wherein the overall range of the floor is subdivided into an upper partial range and a lower partial range, and the floor signal adopts a “within the upper partial range of the range of the floor” state when the elevator car is in the upper partial range and adopts a “within the lower partial range of the range of the floor” state when the elevator car is in the lower partial range.

18. The floor position detection device according to claim 11 wherein the floor signal is mapped by a voltage at an output of the evaluation device or at an output of an output module connected to the evaluation device, and wherein each of the at least two states is characterized by at least a voltage or a voltage range.

19. The floor position detection device according to claim 18 wherein the “within the range of the floor” state is characterized by a plurality of different voltages, each of the different voltages being associated with one of the partial ranges.

20. An elevator control system of an elevator system, the elevator control system comprising;
an elevator control controlling movement of an elevator car, and
the floor position detection device according to claim 11 arranged on the elevator car and in communications connection with the elevator control.

21. An elevator system comprising:
an elevator car movable relative to a floor, and
the elevator control system according to claim 20 controlling the movement of the elevator car.
